(19) United States
(12) Patent Application Publication
(10) Pub. No.: US 2009/0236279 A1
(43) Pub. Date: Sep. 24, 2009

(54) Sand classifying-conveying-dehydrating device

(76) Inventor: Shigeo Yanase, Kisarazu City (JP)

Correspondence Address: HENNEMAN & ASSOCIATES, PLC, 70 N. MAIN ST., THREE RIVERS, MI, 49093, US

(21) Appl. No.: 12/380,599

(22) Filed: Feb. 27, 2009

(30) Foreign Application Priority Data
Mar. 7, 2008 (JP) 2008-58590
Oct. 14, 2008 (JP) 2008-265649

(51) Int. Cl. C02F 1/26

(52) U.S. Cl. 210/249; 210/255

(57) ABSTRACT

(Problems) The present invention provides a sand classifying-conveying-dehydrating device for continuously providing classified sand to a dehydration process, which enables to significantly improve a working efficiency and decrease a space for installing the device.

(Means for Solving Problems) To provide a sand classifying-conveying-dehydrating device for recovering sand from a material including water and sand, comprising: a classifier (100) for transferring the sand contained in the material from upstream to downstream; a dehydrator (300) for removing the water contained in the sand; and a conveyor (200) for delivering the sand from the classifier to the dehydrator, wherein the classifier, the conveyor and the dehydrator are integrally connected in sequence from upstream to downstream.

### CROSS REFERENCE TO RELATED APPLICATION

This application claims the right of foreign priority to Japanese Patent Application No. 2008-58590 (filed on Mar. 7, 2008 by at least one common inventor) and Japanese Patent Application No. 2008-265649 (filed on Oct. 14, 2008 by at least one common inventor), both applications being incorporated herein by reference in their entireties.

### FIELD OF THE INVENTION

The present invention relates to a sand classifying-conveying-dehydrating device for continuously recovering dehydrated sand from a material including water and sand.

### DESCRIPTION OF THE RELATED ART

Generally, a device for transferring only sand from the mixture of water and sand, for example, a classifier described in Japanese Examined Utility Model Application Publication No. 4-17236, is known.

However, the classifier described in the above Publication has high resistance against water flow during a rotation of a spiral blade so as to largely ruffle the water surface in a sedimentation tank with the rotation of the blade. This results in overflowing water including sand from the sedimentation tank and decreasing a sand recovery efficiency.

The above problem may be partly solved by lowering the rotation speed of the spiral blade. However, the lowered rotation speed largely decreases in a processing efficiency.

In the classifier described in the above publication, the spiral blade is formed into a ribbon-shape. Thus, the rotation of the spiral blade causes a dispersion of the sand in water, and most of the dispersed sand flow to downstream through a central hole of the spiral blade. This is also a major factor to decrease the sand recovery efficiency.

Japanese Unexamined Utility Model Application Publication No. 60-63460 discloses a conveyor for transferring sedimentary sand etc. The conveyor comprises a screw conveyor having a screw blade with drain holes.

However, the device described in the above Publication No. 60-63460 allows water to pass only through the small drain holes. Therefore, it is unable to significantly decrease resistance against water flow during a screw rotation.

Thus, even though the screw disclosed in the Publication No. 60-63460 is applied to the classifier described in Publication No. 4-17236, it is unable to solve the problems such as the overflow from the sedimentation tank resulting from the high resistance against water flow as well as the decrease in the processing efficiency.

With respect to the above problems, the present inventor suggested a novel spiral screw classifier in Japanese Patent Application No. 2008-58590.

The spiral screw classifier suggested by the present inventor is excellent in solving the above-mentioned problems of the conventional classifiers.

Here, the sand classified by the classifiers contains a large amount of water so that it requires a dehydrating process.

However, the known classifiers including the device suggested by the present applicant requires taking out the classified sand from the classifier once, and transferring it to a dehydrator disposed on other place to carry out the dehydrator process, which results in a poor working efficiency. In addition, very large space is required to place the classifier and the dehydrator as well as a conveyor for delivering the sand from the classifier to the dehydrator.

### SUMMARY OF INVENTION

The objective of the present invention is to solve the above problems. The present invention provides a sand classifying-conveying-dehydrating device which enables to directly and continuously provide classified sand to a dehydrating process. This results in significantly improving a working efficiency and drastically decreasing a space for installing the device.

One embodiment of the present invention is related to a sand classifying-conveying-dehydrating device for recovering sand from a material including water and sand, comprising: a classifier for transferring the sand contained in the material from upstream to downstream; a dehydrator for removing the water contained in the sand; and a conveyor for delivering the sand from the classifier to the dehydrator, wherein the classifier, the conveyor and the dehydrator are integrally connected in sequence from upstream to downstream.

Another embodiment of the present invention is related to the sand classifying-conveying-dehydrating device according to claim 1, wherein the classifier comprises: a reception tank for receiving the material; a rotatable central shaft in the reception tank, the rotatable central shaft extending in a longitudinal direction of the reception tank; a spiral screw blade defining a central hole surrounding the rotatable central shaft, the spiral screw blade including a contacting surface for the material with a plurality of apertures smaller than the central hole; and annular structures with plurality of apertures aligned along the central shaft in a predetermined pitch, at least one of the annular structures including a surface perpendicular to the central shaft.

Yet another embodiment of the present invention is related to the sand classifying-conveying-dehydrating device according to claim 2, wherein the predetermined pitch of the annular structures is larger than a spiral pitch of the screw blade, and a diameter of each of the annular structures is less than or equal to a diameter of the central hole.

Yet another embodiment of the present invention is related to the sand classifying-conveying-dehydrating device according to claim 2, further comprising: a plurality of supporting members aligned along the central shaft in a predetermined pitch; at least one of the supporting member comprising a plurality of the radical arms and a ring member supported on tips of the radical arms; and a plurality of connection members extending in parallel with a longitudinal axis of the central shaft through the spiral screw and connecting the ring members, wherein the annular structure is attached to the radial arms.

Yet another embodiment of the present invention is related to the sand classifying-conveying-dehydrating device according to claim 1, the conveyor comprises: a conveyance tank including a bottom surface continuously formed with a bottom surface of the reception tank of the classifier; and a rotator placed in the conveyance tank for delivering the sand to downstream as it rotates, wherein the bottom surface of the conveyance tank is tilted downwardly toward downstream; and the rotator comprises a rotating shaft perpendicular to a conveyance direction of the material and a plurality of agitating blades around the rotating shaft.

Yet another embodiment of the present invention is related to the sand classifying-conveying-dehydrating device according to claim 5, wherein the agitating blade around the rotating shaft extends in substantially parallel with the rotating shaft, and a space is formed between the rotating shaft and the agitating blade.

Yet another embodiment of the present invention is related to the sand classifying-conveying-dehydrating device according to claim 6, wherein the agitating blade is substantially complementary contoured with the bottom surface of the conveyance tank in a direction substantially parallel to the rotating shaft.

Yet another embodiment of the present invention is related to the sand classifying-conveying-dehydrating device according to claim 7, comprising: the plurality of the supporting arms radially extending from the rotating shaft; and blade mounting frames fixed to tips of the supporting members, respectively, each of the blade mounting frames configured to fix the agitating blade; and a plurality of curved band plates circumferentially connect the blade mounting frames each other.

Yet another embodiment of the present invention is related to the sand classifying-conveying-dehydrating device according to claim 5, the dehydrator comprising: a rotating shaft extended in the conveyance direction; a plurality of buckets for scooping the sand from the conveyor during a rotation of the rotating shaft of the dehydrator, buckets attached to tips of radial arms extending from the rotating shaft, respectively; a dehydration mechanism for removing water from the scooped sand in the buckets, comprising; a draining net for draining off water from the scooped sand, the drain net placed over a bottom surface of the bucket; a drain tank for receiving water passed through the draining net and stored in the bucket, the drain tank attached to the bucket; and a suction device for sucking interior of the drain tank for a negative pressure therein.

### BRIEF DESCRIPTION OF THE DRAWINGS

Hereinafter, preferred embodiments of the sand classifying-conveying-dehydrating device according to the present invention will be explained with reference to the drawings.

FIG. 1 is a plain view of a sand classifying-conveying-dehydrating device according to the present invention.

FIG. 2 is a front view of a sand classifying-conveying-dehydrating device according to the present invention.

FIG. 3 is a right side view of a sand classifying-conveying-dehydrating device according to the present invention.

FIG. 4 is viewed along arrows A-A of FIG. 1.

FIG. 5 is viewed along arrows B-B of FIG. 1.

FIG. 6 (a) is viewed along arrows C-C of FIG. 1, and (b) is viewed along arrows A-A of (a).

FIG. 7 shows a rotator and a conveyance tank according to a shape alternative embodiment of the present invention, and (a) corresponds to a view along arrows C-C of FIG. 1, and (b) is viewed along arrows A-A of (a).

FIG. 8 is a partial vertical side view of a dehydrator.

FIG. 9 is a partially enlarged perspective view of a bucket and a drain tank of a dehydrator.

FIG. 10 is a partially cutout perspective view of a suction device of a dehydrator.

FIG. 11 is a partially cutout front view of a lid opening and closing member of a dehydrator.

FIG. 12 is a partially cutout front view of a bucket just before entering into a dehydration tank.

FIG. 13 is a partially cutout front view of a bucket during scooping sand.

FIG. 14 is a partially cutout front view of a bucket that is out of a water surface of a dehydration tank.

FIG. 15 is a partially cutout front view to show an enforced dehydration state generated by a vacuum suction.

According to one embodiment of the present invention, a classifier for transferring sand contained in the material from upstream to downstream, a dehydrator for removing water contained in the sand and a conveyor for delivering the sand from the classifier to the dehydrator are integrally connected in sequence from upstream to downstream. This enables to continuously perform processing steps from the classification to the dehydration in a single device and significantly improve the processing efficiency compared to known devices. Further, it is able to install the classifier, the dehydrator and the conveyor, which were conventionally placed separately, as a single device so as to dramatically decrease a space for the installation.

According to another embodiment of the present invention, a screw blade includes a contacting surface for the material with a plurality of apertures and defines a central hole surrounding a central shaft. This allows water to pass through both the apertures and the central hole during a rotation of the screw so as to significantly decrease resistance against water flow. This results in minimizing a ruffle of the water surface in a reception tank, preventing water containing sand from an overflow and improving a sand recovering efficiency.

In addition, the low resistance against water flow allows to accelerate a rotating speed of the screw and lengthen an outer diameter of the blade so as to dramatically increase the processing efficiency.

Further, annular structures with plurality of apertures align along the central shaft in a predetermined pitch, and at least one of the annular structures includes a surface perpendicular to the central shaft. Thus, the annular structures enable to capture the sand contained in water escaping toward downstream through the central hole and transfer the sand toward upstream again, which results in improving the sand recovering efficiency. Also, this feature allows water to pass through not only holes of the annular structure but also a space formed between the spiral screw blade and the annular structure perpendicular to the central shaft. Therefore, the installation of the annular structures hardly increases resistance against water flow. Thus, it is able to keep lower resistance against water flow and improve the sand recovering efficiency.

According to yet another embodiment of the present invention, the predetermined pitch of the annular structures is larger than a spiral pitch of the screw blade. This facilitates the water flow through the central hole of the screw blade without the annular structures's blocking water and improves the sand recovering efficiency.

In addition, a diameter of each of the annular structures is less than or equal to a diameter of the central hole. This configuration allows suitable placement of the annular structures without interfering the screw blade, and also prevents the annular structures from blocking the sand transfer.

According to yet another embodiment of the present invention, fastener means comprising arms, ring members and connecting members is used for not only the screw blade but also the annular structure without any extra attachments for the annular structure, which results in minimizing the increase in resistance against water flow due to an installation of the annular structures. Further, the annular structure is certainly attached to the arms.

Yet another embodiment of the present invention includes a conveyance tank including a bottom surface tilted downwardly toward downstream and a rotator comprising a plurality of agitating blades placed in the conveyance tank for delivering the sand to downstream with their rotation. Thus, the sand is efficiently and certainly transferred from the classifier to the dehydrator by the benefit of both a gravity and agitation from the agitating blade.

Further, the rotator comprises a rotating shaft perpendicular to a conveyance direction of the material and a plurality of agitating blades around the rotating shaft. Thus, a rotating direction of the agitating blade is perpendicular to a rotating direction of the rotating shaft of the classifier. This enables to provide a smooth flow without synchronizing the rotating shaft of the rotator with the rotating shaft of the classifier, which results in improving a sand conveyance efficiency. Further, this enables to reduce a space for the conveyor and downsize the whole device.

According to yet another embodiment of the present invention, the agitating blade around the rotating shaft extends in substantially parallel with the rotating shaft. Thus, a surface of the agitating blade receives a flow transferred from the classifier and further transfers the flow toward downstream, and results in excellent conveyance efficiency.

In addition, a space between the rotating shaft and the agitating blade allows water to pass through the space during a rotation of the rotator and dramatically decreases resistance against water flow so as to efficiently transfer only the sand to the dehydrator.

According to yet another embodiment of the present invention, the agitating blade is substantially complementary contoured with the bottom surface of the conveyance tank in a direction substantially parallel to the rotating shaft. The rotation of the agitating blade efficiently provides a driving power generated by the rotation to the sedimented sand on the bottom surface of the conveyance tank so as to convey the sand with high efficiency.

According to yet another embodiment of the present invention, each of the blade mounting frames is configured to fix the agitating blade, and a plurality of curved band plates circumferentially connect the blade mounting frames each other. This enables to prevent the agitating blade from a vibration caused by resistance against water flow and centrifugal force during the rotation. This increases rotation speed of the rotator to improve the conveyance efficiency.

According to yet another embodiment of the present invention, in the dehydrator, a drain net is used to remove water and subsequently a suction device does the same from the sand scooped by a bucket, which makes a dehydration process more efficient and shorter.

### DETAILED DESCRIPTION OF THE INVENTION

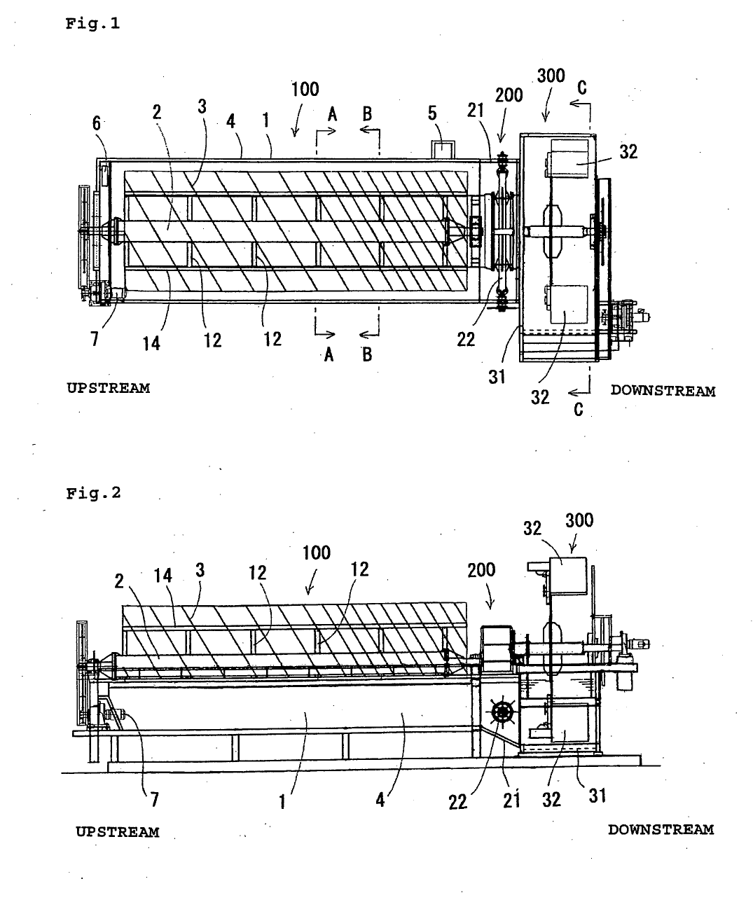

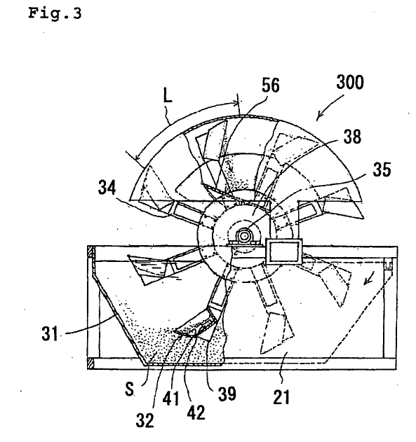

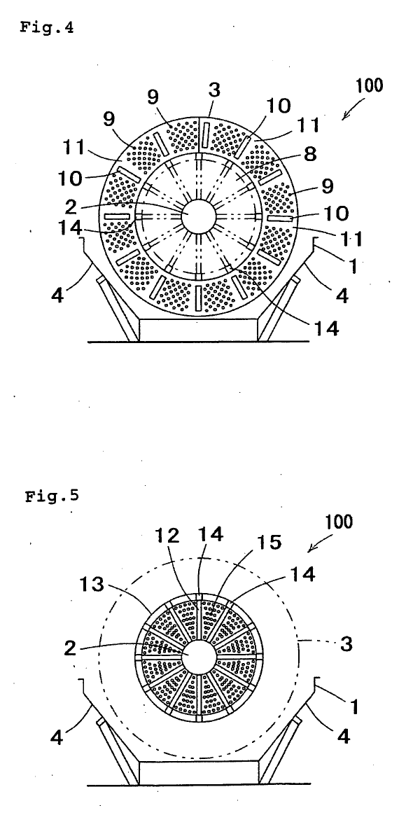

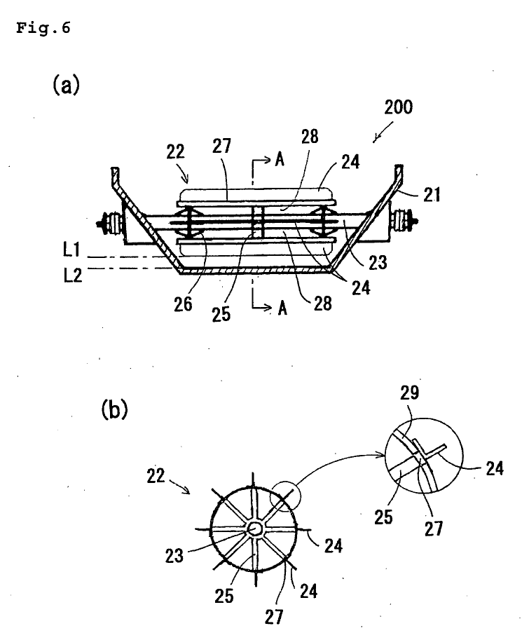

FIG. 1 is a plain view of a sand classifying-conveying-dehydrating device according to the present invention. FIG. 2 is a front view of a sand classifying-conveying-dehydrating device according to the present invention. FIG. 3 is a right side view of a sand classifying-conveying-dehydrating device according to the present invention. FIG. 4 is viewed along arrows A-A of FIG. 1. FIG. 5 is viewed along arrows B-B of FIG. 1. FIG. 6 (a) is viewed along arrows C-C of FIG. 1, and (b) is viewed along arrows A-A of (a). In FIG. 6 (b), a tank is omitted.

A device according to the present invention is configured to dehydrate and recover sand from a material including water and sand (mixture of water and sand). The device comprises a classifier (100) for transferring the sand contained in the material from upstream to downstream, a dehydrator (300) for removing the water contained in the sand, and a conveyor (200) for delivering the sand from the classifier (100) to the dehydrator (300).

The classifier (100), the conveyor (200) and the dehydrator (300) are integrally connected in sequence from upstream to downstream.

Thus, the classifier (100), the conveyor (200) and the dehydrator (300) are integrated in a single device so as to continuously flow the material from the classifier (100) to the conveyor (200) and subsequently to the dehydrator (300).

Firstly, the classifier (100) will be explained.

The classifier (100) comprises a reception tank (1) for receiving the material including water and sand as well as a spiral screw provided in the reception tank (1)

The spiral screw comprises a rotatable central shaft (2) provided in a longitudinal direction of the reception tank (1) and a screw blade (3) spirally-provided along a peripheral surface of the central shaft (2).

The reception tank (1) is rectangular in a planar view. The reception tank (1) includes a horizontal bottom surface and a top opening.

Side walls (4) define an upwardly tapered shape. A top edge of the side wall (4) is slightly below a center axis of the central shaft (2) (See FIG. 4 and FIG. 5).

The reception tank (1) comprises a supply inlet (5) for providing the material into the tank and a drain outlet (6) for draining water separated from the material outside the tank.

The supply inlet (5) protrudes outwardly from one of the side walls (4) in a vicinity of a longitudinal end of the reception tank (1). The supply inlet (5) is upwardly opened. Then, the material supplied from the supply inlet (5) is introduced through an opening in the side wall (4) of the reception tank (1) to the bottom of the reception tank (1).

The drain outlet (6) is provided at another longitudinal end of the reception tank (1). The drain outlet (6) is upwardly opened below the top edge of the side wall (4). Thus, water overflowed from an area (a pool) in which spiral screw of the reception tank (1) is provided drains outside through the drain outlet (6).

The central shaft (2) of the spiral screw is connected to a motor (7) provided at the another end of the reception tank (1) by using known connecting means such as a pulley and a belt. The central shaft (2) rotates with a driving of the motor (7).

The motor (7) may be an inverter motor which is capable of changing a rotating speed according to a load to the central shaft (2) to decrease the rotating speed when the central shaft (2) is subjected to a high water load or to increase the rotating speed when the central shaft (2) is subjected to a low water load so as to maximize the processing efficiency and the recovering efficiency.

The spiral screw blade (3) transfers the sand included in the material from the another end (upstream) of the reception tank (1) to the one end (downstream) of the reception tank (1) (i.e., a direction from the drain outlet (6) to the supply inlet (5)) with the rotation of the central shaft (2).

The screw blade comprises a band plate in a constant width which spirally extends around the central shaft (2) with defining a central hole (8) surrounding the central shaft (2) (See FIG. 4).

The central hole (8) allows water around the central shaft (2) to flow toward downstream during the rotation of the screw. Most of the sand contained in the material sediment on the bottom of the reception tank (1) so that the water flowing through the central hole (8) to downstream is substantially sand-free.

Therefore, the central hole (8) dramatically decreases resistance against water flow without substantially reducing the sand recovering efficiency.

A diameter of the central hole (8) needs to be set within a suitable range, since too small diameter results in insufficient water flow while too large diameter considerably decreases the conveyance efficiency. The diameter of the central hole (8) may be preferably set to 50 to 60% length of the diameter of the screw blade (3).

The screw blade (3) includes a surface (substantially perpendicular to the central shaft (2)) which contacts with the material, and many apertures (9) are aligned in the substantially whole surface (See FIG. 4).

The apertures (9) allow water included in the material which contacts with the screw blade (3) to flow downstream during the rotation of the screw so as to decrease resistance against water flow.

The apertures (9) are configured to pass through water in a vicinity of the reception tank bottom on which the sand is sedimented, while the above-described central hole (8) is configured to pass substantially sand-free water through around the central shaft. Therefore, the apertures (9) have to be smaller than the central hole (for example, 1/10 to 1/15) to restrict sand passage.

In addition, fine substances included in the material pass through the apertures (9) with water so as to efficiently convey only the sand exceeding a predetermined particle.

The apertures (9) are circular in FIG. 4, however, other shapes such as triangular and quadrangular may be also used.

A size of the apertures (9) may be set depending on a particular diameter of the sand to be recovered as a product. For example, the diameter of the apertures (9) is set to 10 mm when the sand to be recovered is fine sand with a diameter of 1.5 mm or less. In this case, the diameter of the central hole (8) is set to about 1,500 mm.

The above described feature of two different sizes of water passage, such as the larger central hole (8) that the screw blade (3) defines around the central shaft (12) and the smaller apertures (9) on the screw blade (3) apart from the central shaft (2) significantly decreases resistance against water flow without worsening the sand conveyance efficiency. Thus, the present invention solves these contradictory problems at the same time.

Ribs (10) radially extending are circumferentially and protrusively placed at a constant pitch to support a back side of the screw blade (3) (downstream), as shown in FIG. 4.

These ribs (10) strengthen the screw blade (3), as well as pulverize agglomerates of the sand sedimented on the bottom surface of the reception tank (1) with the rotation of the screw blade (3) so as to smoothly transfer the sand.

If the ribs (10) are placed on a front side (upstream) of the screw blade (3), the ribs disturb the sand transfer along the front side of the screw blade. On the other hand, the ribs on the back side exhibit only the advantageous pulverization so as to smoothly transfer the sand without disturbing the sand transfer.

The screw blade (3) also includes hole-free areas (11) without any apertures (9) which are biased to the advance side of rotational direction with respect to the ribs (10).

Such hole-free areas (11) reduce the water flow passing through apertures (9) at the advanced side of the ribs (10) so as not to disturb the above-described pulverization.

Spiral pitch of the screw blade (3) around the supply inlet (5) of the material for the reception tank (1) (upstream in the conveyance direction) is smaller than other areas (downstream in the conveyance direction).

For the details, the spiral pitch around to the supply inlet is set to ½ or less compared to that in the other areas. Specifically, the spiral pitch around the supply inlet may be set to 250 mm, while the pitch in the other areas may be set to 500 mm.

The smaller spiral pitch of the screw blade (3) around the supply inlet of the reception tank (1) results in efficiently transferring the sand contained in the material provided from the supply inlet, while the larger spiral pitch in the other areas reduces resistance against water flow.

This results in solving contradictory problems, which are the improvement of the sand conveyance efficiency and the decrease of resistance against water flow, at the same time.

The supporting member (12) comprises multiple arms which radially and perpendicularly extending with respect to the peripheral surface of the central shaft (2). A structure of multiple arms with radical arrangement, as illustrated, is referred to as the supporting member (12) in the present invention.

A plurality of the supporting members (12) are aligned in the longitudinal direction of the central shaft (2) at a predetermined interval.

Tips of the multiple arms included in each of the supporting members (12) are connected together by means of a ring member (13) (See FIG. 5).

Multiple connection members (14) extending in the longitudinal direction of the central shaft (2) provide connection among ring members (13) of the supporting members (12), respectively.

The same number of the connection members (14) as the number of the arms (12 in Figs) is provided, so that the connection members (14) connect the ring members at the distal ends of the arms, respectively.

The connection member (14) has the same length as the central shaft (2) and is placed in parallel with it. The connection member (14) connection among the ring members (13) results in connection among the screw blades (3).

Thus, the screw blade (3) is fixed to the central shaft (2) via the connection member (14), ring member (13) and the supporting member (12).

FIG. 5 shows a plurality of porous plates (15) configured to close spaces among the arms of each of the supporting members (12) aligning along the central shaft (2) so that a set of the porous plates (15) in each supporting member (12) forms an annular structure perpendicular to the central shaft.

This enables to strongly fix the porous plates (15) so as to avoid damage caused by the force from the material during the driving.

The supporting member (12) for fixing the screw blade (3) to the central shaft (2) may also be used to fix the porous plates (15). Thus, it is not necessary to use any additional members for attaching the porous plates (15). This results in reducing the number of parts to be used, and minimizing the increase of resistance against water flow due to the installation of the porous plate (15).

A shape of the hole in the porous plates (15) is circular in FIG. 5, however, other shapes such as triangular and quadrangular may be also used.

A diameter of hole in the porous plate (15) may be set to the same as the apertures (9) formed in the screw blade (3), for example 10 mm.

The annular structures (15) (a set of the porous plates (15)) are configured to capture the sand contained in water flowing downstream through the central hole (8) and transfer the captured sand to upstream again by using the rotation of the screw blade (3). This results in drastically improving the sand recovering efficiency.

Also, this enables to pass water through holes of the porous plate (15) so that the installation of the annular structures (15) hardly increases the resistance against water flow to lower the resistance against water flow and improve the sand recovering efficiency.

In addition, the screw blade (3) is tilted with respect to the central shaft (2), while the annular structures (15) are placed perpendicular to the central shaft (2). Thus, a space is certainly formed between the central blade (3) and the annular structures (15) so as to escape water through the space. This also enables to reduce the increase of resistance against water flow resulting from the installation of the annular structures (15).

An arranging pitch of the annular structures (15) (same as the arranging pitch of the supporting members (12)) is larger than the spiral pitch of the screw blade (3) as shown in FIG. 1 and FIG. 2.

For the details, the arranging pitch of the annular structures (15) is set to about 5 to 6 times of the spiral pitch of the screw blade (3) around the supply inlet, and set to about 3 to 4 times of that in the other areas (the spiral pitch of the screw blade (3) is described above). Specifically, for example, the pitch of the annular structures (15) may be set to 1,500 mm when the spiral pitch of the screw blade (3) around the supply inlet is 250 mm, and the spiral pitch in the other areas is 500 mm.

Thus, the arranging pitch of the annular structures (15) is larger than spiral pitch of the screw blade (3). This minimizes the block of the water flow through the central hole (8) defined by the screw blade (3) due to the annular structure (15), and results in improving the sand recovering efficiency.

The diameter of the annular structure (15) is set to less than or equal to that of the central hole (8), so that the annular structure (15) do not interfere with the screw blade. Also, the annular structure (15) does not block the sand transfer caused by the rotation of the screw blade. In Figs, the diameter of the annular structure (15) is set to smaller than that of the central hole (8) by just a width of the ring member (13).

As described above, the classifier (100) comprises several structures to decrease resistance against water flow and improve the sand recovering efficiency at the same time. These structures synergistically work with the rotation of the screw blade.

Next, a conveyor (200) will be explained.

The conveyor (200) comprises a conveyance tank (21) of which a bottom surface is continuously formed with a bottom surface of the reception tank (1) of the classifier (100) and a rotator (22) placed in the conveyance tank for delivering the sand to downstream as it rotates.

The bottom surface of the conveyance tank (21) is tilted downwardly to downstream as shown in FIG. 2. The proximal end (upstream edge) of the conveyance tank (21) is leveled with the bottom surface in the reception tank (1) of the classifier (1) while the distal end (downstream edge) of the bottom surface of the conveyance tank (21) is leveled with the bottom surface in a dehydration tank (31) of the dehydrator (300). The tilted bottom surface of the conveyance tank (21) facilitates to transfer the sand from the classifier (100) to the dehydrator (300) by the benefit of gravity with which an agitation blade (24) (described below) certainly facilitates the sand transfer as well to enhance its efficiency.

Next, the rotator (22) will be explained with reference to FIG. 6.

The rotator (22) comprises a rotating shaft (23) extending perpendicular to a conveyance direction of the material (width direction of the conveyance tank (21)) and driven by a motor (not shown) as well as multiple agitating blades (24) around the rotating shaft (23).

The agitating blade (24) comprises an angle member with L-shaped cross-section. The agitating blade (24) around the rotating shaft (23) extends in substantially parallel with the rotating shaft (23) across almost all length of the bottom surface of the conveyance tank (21). A blade mounting frame (27) attaches the agitating blade (24) with each tip of the supporting members (8 supporting members shown in FIG. 6) radially extending from the rotating shaft (23).

More specifically, the liner rod frame (27) for mounting the agitating blade (24) connects the supporting member (25) placed at a longitudinally intermediate position of the rotating shaft (23) with supplemental supporting members (26) at both ends of the rotating shaft (23). The agitating blades (24) are attached along entire length of the blade mounting frames (27), respectively.

The rotator (22) rotates in a counterclockwise direction (in FIG. 2) so as to make a water flow from upstream (classifier end) to downstream (dehydrator end) in a vicinity of the bottom of conveyance tank (21).

The sand transferred from the classifier (100) sediments on the bottom of the conveyance tank (21) with its own weight. Then, the rotator (22) generates the water flow in a vicinity of the bottom so as to efficiently transfer the sedimented sand to the dehydrator (300).

As described above, the bottom surface of the conveyance tank (21) is tilted downwardly toward downstream, so that water flow and gravity advantageously affect the sand transfer to the dehydrator (300).

A space (28) between the rotating shaft (23) and the agitating blade (24) (more specifically, between the rotating shaft (23) and the blade mounting frame (27) to which the agitating blade (24) is attached) allows water to pass there through during the rotation of the rotator (22), which dramatically reduces resistance against water and efficiently transfers only the sand to the dehydrator (300).

The agitating blade (24) substantially parallel to the rotating shaft (23) is substantially complementary contoured with the bottom surface of the conveyance tank (21).

In FIG. 6, the conveyance tank (21) includes a linear bottom surface substantially parallel to the rotating shaft (23) while the linear agitating blade (24) extends in the same direction. Thus, line (L1) and line (L2) shown in FIG. 6 are parallel to each other.

This enables to unbiasely and uniformly apply a driving power of the water flow generated by the rotation of the agitating blade (23) to the sedimented sand on the bottom surface of the conveyance tank (21) during the rotation, which results in transferring the sand with high efficiency.

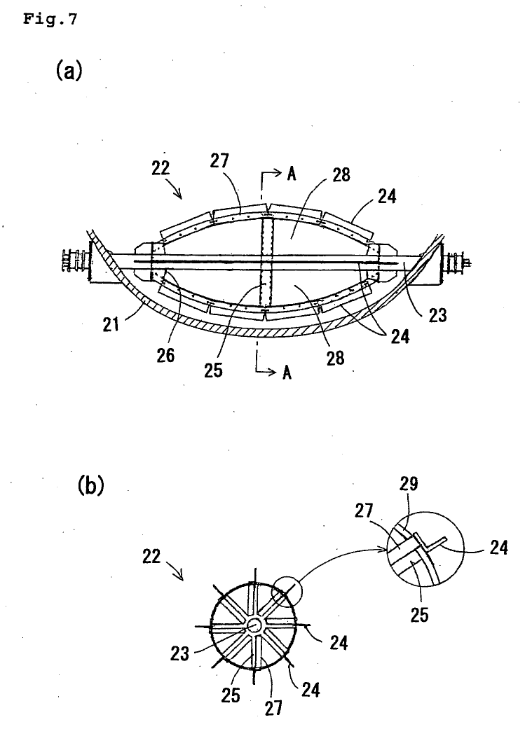

In the present invention, shapes of the rotator (22) and the conveyance tank (21) are not limited to the above, and shapes shown in FIG. 7 may be also used.

FIG. 7 shows an alternative embodiment of shapes of the rotator (22) and the conveyance tank (21). FIG. 7 (a) corresponds to a view along arrows C-C of FIG. 1, and (b) is viewed along arrows A-A of (a).

This alternative embodiment also shows that the agitating blades (24) around the rotating shaft (23) extend in substantially parallel with the rotating shaft (23).

The agitating blade (24) substantially parallel to the rotating shaft (23) is substantially complementary contoured with the bottom surface of the conveyance tank (21).

Specifically, the agitating blade (24) forms a convexed arc in a direction away from the rotating shaft (23). The arc extends in substantially parallel with the rotating shaft (23). The bottom surface of the conveyance tank (21) forms a downwardly-convexed arc in substantially parallel with the rotating shaft (23).

This alternative embodiment also enables to unbiasely and uniformly apply the driving power of the water flow generated by the rotation of the agitating blade (23) to the sedimented sand on the bottom surface of the conveyance tank (21) during the rotation so as to transfer the sand with high efficiency.

In the alternative embodiment, larger space (28) is formed between the rotating shaft (23) and the agitating blade (24) so as to additionally reduce and lower resistance against water flow.

In the rotator (22) shown in FIG. 6 and FIG. 7, a band plate forming a curved arc (29) connects one of the blade mounting frames (27) to another circumferentially adjacent blade mounting frame (27) around the rotating shaft (23). The band-shaped plates (29) form an annular structure (15) surrounding the central shaft (23).

The band-shaped plate (29) connects the blade mounting frames (27) placed on tips of the supporting members (25) each other so as to prevent the agitating blade (24) from a vibration resulting from resistance against water flow and centrifugal force during the rotation. This results in high speed operation of the rotator and improved conveyance efficiency.

A rotating direction of the rotating shaft (23) to which the agitating blade (24) is attached is perpendicular to the rotating direction of the rotating shaft (2) of the classifier (100).

The rotation of both of the rotating shafts needs to be synchronized to generate a smooth flow if the rotating directions of both of the rotating shafts are the same (rotating surfaces are parallel to each other). However, it is able to generate the smooth flow without the synchronization when the rotating directions of both of the rotating shafts are perpendicular to each other (rotating surfaces are perpendicular to each other). As a result, this enables to adjust the rotating speed of the rotating shaft (23) independently from the rotating speed of the rotating shaft (2), which results in improving the sand conveyance efficiency.

Further, this also contributes to reduction of the space for the conveyor (200) and downsizing the whole device.

The agitating blade (24) around the rotating shaft (23) extends in substantially parallel with the rotating shaft (23). This enables to receive the flow transferred from the classifier (100) on a surface of the agitating blade (24) and transfer the flow to the dehydrator (300), which results in excellent conveyance efficiency.

Lastly, the dehydrator (300) will be explained. The dehydrator (300) comprises a dehydration tank (31) of which a bottom surface is continuously formed with the bottom surface of the conveyance tank (21) of the conveyor (200), multiple buckets (32) placed in the dehydration tank (31) for scooping the sand transferred from the conveyor (200), and a dehydration mechanism for removing water from the scooped sand in the multiple buckets (32). The dehydration mechanism is omitted in FIG. 1 and FIG. 2. The multiple buckets (32) are attached to tips of the multiple arms (34) (8 in FIG. 3) which radially extends around the rotating shaft (33) extending in parallel with the conveyance direction.

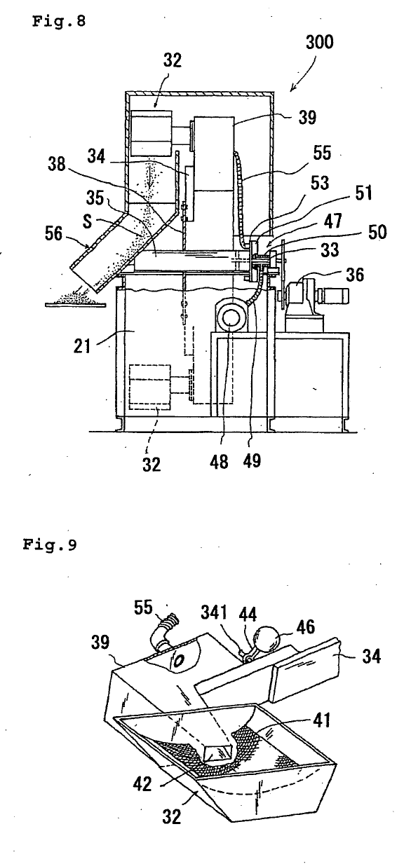

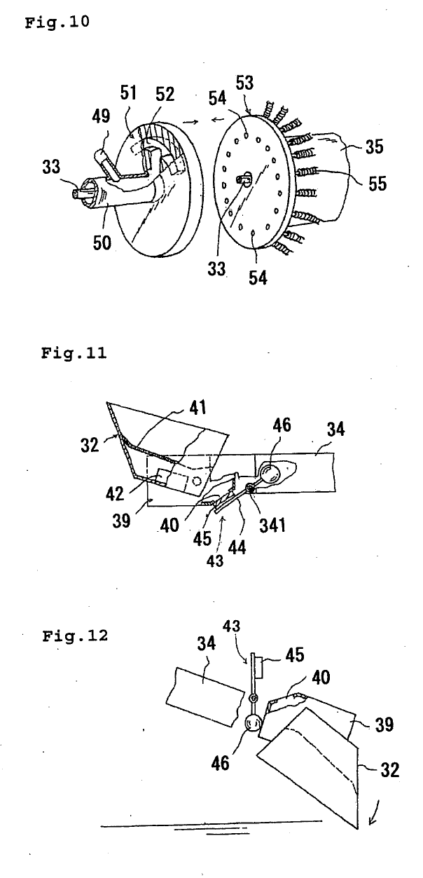

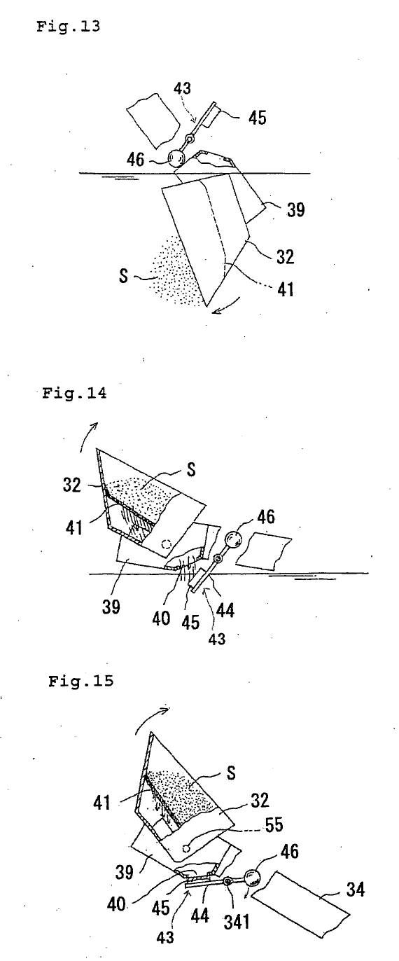

Hereinafter, further details of the dehydrator (300) will be explained with referring to FIG. 8 to FIG. 15.

A rotating tube (35) is supported on a top of the dehydration tank (31). A rotating shaft (33) rotated by a motor placed in a back area fixes the rotating tube (35) thereon, and rotates the rotating tube (35).

A disk-shaped attaching member (38) is fixed in the middle of the rotating tube (35) in the axial direction. Multiple radial arms (34) are attached to the attached member (38). Drain tanks (39) are attached to tips of the arms, respectively. Buckets (32) are connected to the front surfaces of the drain tanks (39), respectively.

Thus, the drain tank (39) is fixed to a back side of a tip of the arm (34). A front side of the tip of the drain tank (39) is fixed to a lower part of bucket (32), and the bucket (32) is forward and protrusively placed from a side view.

The bucket (32) is upwardly opened. A draining net (41) divides the inside of the bucket (32) into an upper part in which the sedimented sand (sediment) are stored and a lower part through which the drained/separated water drops.

The tilted tip of the bucket (32) facilitates to scoop the sand.

A drain tank (39) at a lower back end has a drain hole (40) configured to connect with a drain outlet (42) below the drain net of the bucket (32) so as to receive the separated water after passing through the drain net (41) and return the water from the drain hole (40) to the dehydration tank (21) for drainage. The drain tank (39) is slightly tilted downward and fixed to the bucket (32) so as to facilitate passage of the separated water after passed through the drain net (41).

FIG. 11 discloses a member (43) configured to open and close a lid is for the drain hole (40). A seesaw (44) is attached to a protruding shaft (341) of the arm (34). A rubber lid (45) for closing the drain hole (40) of the drain tank is provided at one end of the seesaw (44), and a weight heavier than the lid (45) is attached to another end of the seesaw (44).

A suction device (47) sucks interior of the drain tank (39) during upward rotation of each bucket (32) from a substantially horizontal position to a vertical position.

A suction tube (49) is connected to an suction side of a blower (48) which causes vacuum suction and subsequently connected to a fixing tube (50) containing the rotating shaft (33). This evacuates a communication groove (52) of an immobile suction plate (51) that is fixed to the fixing tube (50).

The communication groove (52) is formed by a cut out in the area from a substantially horizontal position to a vertical position inside the suction plate (51), and open on a front surface.

A control plate (53) is fixed to a back end of the rotating tube (35), and circumferentially and equally spaced through-holes (54) go right through the control plate (53) so as to connect and face to the suction plate (51).

Suction hoses (55) communicate into each through-hole (54) on a front surface of the control plate (53), and open into and connect with a back end of the drain tank (39).

A drain chute (56) is provided above the center of the dehydrator (300) and placed below the bucket (32) that flips and rotates backward.

Hereinafter, functions of the dehydrator (300) will be explained.

At first, the sand is transferred from the conveyance tank (21) to the dehydration tank (31), and the sand (S) sediments in the bottom of the dehydration tank (31).

Next, the rotating tube (35) slowly rotates according to a drive of a motor (36), and each of the buckets (32) scoops the sedimented sand (S) in the bottom as shown in FIG. 3. Then, the separated water falls through the drain net (41) and drains from the drain hole (40) of the drain tank (39) as shown in FIG. 14.

At this time, the lid (45) starts to block the drain hole (40) resulting from a decline of the weight (46), however, high drain pressure pushes the lid (45) so as to drain the water.

Here, the actuation of the blower (48) maintains the communication groove (52) of the suction plate (51) connected to the suction tube (49) as a vacuum state. Thus, the through-holes (54) of the control plate (53) communicate with the communication groove (52) by means of the suction hoses (55) within a rotational displacement range that each bucket (32) moves from a substantially horizontal position upwardly (range shown with an arrow (L) in FIG. 3). Thus, the control plate (53) rotates together with the rotating tube (35) while facing to the suction plate (51) so that the through-holes (54) communicate with the communication groove (52).

Thus, it is able to suck the interior of the drain tank (39) and generate a negative pressure state in the drain tank (39). This allows outer air to pass through the sand held in the bucket (32). This results in removing water residing between sand (S), guiding the removed water to the drain tank (39) and forcibly dehydrating the sand (S).

At this time, within the rotational displacement range shown with an arrow (L) in FIG. 9, which is a suction action range, the gravity of the weight (46) moves the lid (45) upwardly against the weak drain pressure resulting from the decrease of drainage, and the lid (45) strongly blocks the drain hole (40) of the drain tank (39) with a sucking force. This enables to prevent outer air from coming, and achieves an excellent suction and dehydration. In addition, the separated water that is dehydrated by the vacuum suction stays in the drain tank (39).

The bucket (32) starts rotating backward after finishing the enforced dehydration with the vacuum suction, and the sand (S) falls into the drain chute (56) as shown in FIG. 8. At this time, the water that is left in the drain tank (39) does not fall into the dehydration tank (21) because the drain hole (40) is blocked by a lid (45). However, it does not cause any problems if the water pressure opens the lid (45) and the water falls into the dehydration tank (21). In addition, the water does not fall into the drain chute (56).

As explained above, the device according to the present invention enables to transfer the material including water and sand to the classifier (100). The action of the classifier (100) enables to transfer only the sand with over a certain particle diameter to the conveyor (200). The action of the conveyor (200) enables to deliver the sand to the dehydrator. Finally, the action of the hydrator (300) enables to dehydrate and recover the sand.

Accordingly, the single device enables to continuously perform the steps from the classification and the dehydration, and results in improving the working efficiency about 2 to 3 times compared to the conventional devices which have a classifier and a dehydrator separately.

### INDUSTRIAL APPLICABILITY

The sand classifying-conveying-dehydrating device according to the present invention is useful to efficiently recover only sand from the mixture of water and sand.

What is claimed is:

1. A sand classifying-conveying-dehydrating device for recovering sand from a material including water and sand, comprising:
a classifier for transferring the sand contained in the material from upstream to downstream;
a dehydrator for removing the water contained in the sand; and
a conveyor for delivering the sand from the classifier to the dehydrator, wherein the classifier, the conveyor and the dehydrator are integrally connected in sequence from upstream to downstream.

2. The sand classifying-conveying-dehydrating device according to claim 1, wherein the classifier comprises:
a reception tank for receiving the material;
a rotatable central shaft in the reception tank, the rotatable central shaft extending in a longitudinal direction of the reception tank;
a spiral screw blade defining a central hole surrounding the rotatable central shaft, the spiral screw blade including a contacting surface for the material with a plurality of apertures smaller than the central hole; and
annular structures with plurality of apertures aligned along the central shaft in a predetermined pitch, at least one of the annular structures including a surface perpendicular to the central shaft.

3. The sand classifying-conveying-dehydrating device according to claim 2, wherein
the predetermined pitch of the annular structures is larger than a spiral pitch of the screw blade, and
a diameter of each of the annular structures is less than or equal to a diameter of the central hole.

4. The sand classifying-conveying-dehydrating device according to claim 2, further comprising:
a plurality of supporting members aligned along the central shaft in a predetermined pitch;
at least one of the supporting member comprising a plurality of the radical arms and a ring member supported on tips of the radical arms; and
a plurality of connection members extending in parallel with a longitudinal axis of the central shaft through the spiral screw and connecting the ring members, wherein the annular structure is attached to the radial arms.

5. The sand classifying-conveying-dehydrating device according to claim 1, the conveyor comprises:
a conveyance tank including a bottom surface continuously formed with a bottom surface of the reception tank of the classifier; and
a rotator placed in the conveyance tank for delivering the sand to downstream as it rotates, wherein
the bottom surface of the conveyance tank is tilted downwardly toward downstream; and
the rotator comprises a rotating shaft perpendicular to a conveyance direction of the material and a plurality of agitating blades around the rotating shaft.

6. The sand classifying-conveying-dehydrating device according to claim 5, wherein
the agitating blade around the rotating shaft extends in substantially parallel with the rotating shaft, and
a space is formed between the rotating shaft and the agitating blade.

7. The sand classifying-conveying-dehydrating device according to claim 6, wherein the agitating blade is substantially complementary contoured with the bottom surface of the conveyance tank in a direction substantially parallel to the rotating shaft.

8. The sand classifying-conveying-dehydrating device according to claim 7, comprising:
the plurality of the supporting arms radially extending from the rotating shaft; and
blade mounting frames fixed to tips of the supporting members, respectively, each of the blade mounting frames configured to fix the agitating blade; and
a plurality of curved band plates circumferentially connect the blade mounting frames each other.

9. The sand classifying-conveying-dehydrating device according to claim. 5, the dehydrator comprising:
a rotating shaft extended in the conveyance direction;
a plurality of buckets for scooping the sand from the conveyor during a rotation of the rotating shaft of the dehydrator, buckets attached to tips of radial arms extending from the rotating shaft, respectively;
a dehydration mechanism for removing water from the scooped sand in the buckets, comprising;
a draining net for draining off water from the scooped sand, the drain net placed over a bottom surface of the bucket;
a drain tank for receiving water passed through the draining net and stored in the bucket, the drain tank attached to the bucket; and
a suction device for sucking interior of the drain tank for a negative pressure therein.
